(19) United States
(12) Patent Application Publication
(10) Pub. No.: US 2016/0185609 A1
(43) Pub. Date: Jun. 30, 2016

(54) 4A-TYPE MOLECULAR SIEVE SYNTHESIS METHOD

(71) Applicant: CHINA UNIVERSITY OF PETROLEUM-BEIJING, Beijing (CN)

(72) Inventors: Xiaojun BAO, Beijing (CN); Yuanyuan YUE, Beijing (CN); Tiesen LI, Beijing (CN); Haiyan LIU, Beijing (CN); Gang SHI, Beijing (CN); Jinbiao YANG, Beijing (CN)

(21) Appl. No.: 14/895,481

(22) PCT Filed: Dec. 2, 2013
(86) PCT No.: PCT/CN2013/088323

§ 371 Date: Mar. 3, 2016

(30) Foreign Application Priority Data
Jun. 3, 2013 (CN) 201310217164.5

(51) Int. Cl. C01B 39/18

(52) U.S. Cl. CPC C01B 39/18

(57) ABSTRACT

The present invention relates to a synthesis method of zeolite 4A, wherein natural clay mineral, provided as the total silicon source and aluminum source required for molecular sieve synthesis, is activated before they are crystallized under hydrothermal conditions to synthesize zeolite 4A. In the method of the present invention, a simple process is employed and inexpensive raw materials are used, resulting in zeolite 4A having a whiteness of 90% or more and a calcium ion exchange capacity of no less than 310 mg CaCO₃/g zeolite. According to the present invention, the range of raw materials for the preparation of molecular sieve materials is broadened, and therefore not only the cost for molecular sieve production is greatly reduced by using the sub-molten salt activation method, but also the greenness in the production process of molecular sieve materials is significantly improved.

### FIELD OF THE INVENTION

The present invention pertains to the field of molecular sieve synthesis, and particularly relates to a synthesis method of zeolite 4A essentially comprising using natural clay mineral activated by sub-molten salt method as raw material to provide the total silicon source and aluminum source required for zeolite 4A synthesis.

### BACKGROUND

NaA type molecular sieves, having an ideal unit cell composition of Na₉₆[(Al₉₆Si₉₆)O₃₈₄].216H₂O, belong to cubic crystal system and space group Fm-3c, with a unit cell parameter of a=24.61 Å. In the framework structure of NaA type molecular sieves, eight β cages, interlinked by dual 4-member rings with each other, are positioned at the eight vertices of a cube, enclosing an α cage that communicates with adjacent α cages via an 8-member ring. This 8-member ring is the principle channel in NaA type molecular sieves with a pore size of 4.2 Å, and NaA type molecular sieves are therefore also referred to as “zeolite 4A”. After exchange with K⁺ and Ca⁺, NaA molecular sieves become 3A and 5A type molecular sieves, respectively. Due to the channel characteristics and high exchange capacity of NaA molecular sieves, they are one of the most widely exploited molecular sieves, primarily used in detergents, drying and purification of gases, separation of atmospheric nitrogen and oxygen, and the like.

At present, synthesis methods of zeolite 4A may be categorized into two classes based on the source of raw materials: synthesis by using chemicals, and synthesis by using natural minerals. Despite of the well established processes and technology, zeolite 4A synthesis using traditional inorganic chemicals as raw materials has high cost during production and poor economical efficiency. As such, if zeolite 4A could be synthesized directly from natural minerals rich in silicon and aluminum as raw materials, not only is there a wide range of sources of raw materials, but the synthesis route starting from raw materials to the molecular sieve product may be greatly shortened, energy consumption, mass consumption and pollutant emission can be significantly lowered, and the manufacture cost may be markedly reduced, which shows great prospect of development. Currently, most of the published reports on zeolite 4A synthesis with natural minerals as raw materials focuses on natural kaolin minerals.

Kaolin is a 1:1 type dioctahedral layered aluminosilicate clay mineral, with a typical chemical composition Al₂O₃.2SiO₂.2H₂O, wherein the silica-to-alumina ratio is close to that of zeolite 4A. It was discovered that kaolin calcinated at a certain temperature may lose its structural water and be converted to metakaolin having a very high activity. As compared to a process for zeolite 4A synthesis using inorganic chemicals as raw materials, use of kaolin as raw materials in zeolite 4A synthesis can remarkably lower the cost for raw materials, and kaolin is therefore an ideal raw material for zeolite 4A synthesis.

In 1960s, Howell successfully synthesized A type molecular sieves with a two-stage method using thermally activated kaolin as raw material. Subsequently, Ethyl Corporation (US) and Bayer Group (France) successively industrialized this for manufacture of detergents in place of sodium tripolyphosphate. Reports on NaA type molecular sieve synthesis using kaolin had been increasing ever since.

In 1988, Costa et al. (Industrial & Engineering Chemistry Research, 1988; 27(7): 1291-1296) synthesized a NaA type molecular sieve for detergents by calcinated kaolin as raw material. With investigation on condition for gel formation and conditions for aging and crystallization, optimal process parameters for NaA type molecular sieve synthesis were determined, and scale-up experiments were conducted. Also, the mother liquor was recycled so as to lower to synthesis cost to 0.43 $/kg.

Sanhueza et al. (Journal of Chemical Technology & Biotechnology, 1999; 74(4): 358-363) synthesized a NaA type molecular sieve using Chilean kaolin as raw material under autogenous pressure conditions and extensively studied factors that influence the molecular sieve synthesis. By changing mass ratio of starting reactants, with analysis of the crystallized product by means of X-ray diffraction (XRD), scanning electronic microscopy (SEM), differential thermal analysis (DTA) and the like, as well as investigation of the cation exchange capacity of the synthesized molecular sieve, it was determined that the optimal synthesis conditions for NaA type molecular sieves were: a molar SiO₂/Al₂O₃ of 2.5, a molar Na₂O/SiO₂ of 1.0, a molar H₂O/Na₂O of 50, a crystallization time of 15 h, with a crystallization temperature of 100° C.

Selim et al. (Microporous and Mesoporous Materials, 2004; 74(1-3): 79-85) synthesized NaA type molecular sieves in a hydrothermal crystallization process using Egyptian kaolin in an alkaline system. Molecular sieves having various nickel ion exchange degree were prepared, performance thereof in sunflower oil hydrogenation was studied, and the results demonstrates the nickel-exchanged molecular sieves showed a relatively high catalytic activity.

CN1350053A discloses a method of synthesizing zeolite 4A using waste alkali from aluminum plant and kaolin, wherein used NaOH solution and natural kaolin are used as starting materials, and kaolin is activated by alkali fusion, followed by processes including gelling and crystallization etc. to obtain zeolite 4A having calcium exchange capacity of up to 310 mg CaCO₃/g zeolite or more.

CN101591025A discloses a method of preparing adhesive-free A type molecular sieves using kaolin, wherein inexpensive ordinary natural kaolin used as raw material is initially shaped and granulated, then calcinated before it is mixed with a NaOH solution for aging and crystallization, and finally separated, washed, and dried to afford the product. The adhesive-free A type molecular sieves prepared in this invention are characteristic in the strong absorption ability and stable performance thereof.

CN1287971A discloses a novel process of synthesizing zeolite 4A by alkali fusion using kaolin, which process includes: evenly grinding kaolin in a mixture with alkali, followed by calcination, extraction with water, gelling, and crystallization, to synthesize zeolite 4A. Zeolite 4A prepared has a calcium exchange capacity of up to 310 mg CaCO₃/g zeolite. This invention is advantageous in the wide range of suitable kaolin, good gelling performance, high utilization rate, and its simple and practical procedures.

Abdmeziem et al. (Applied Clay Science, 1989, 4(1): 1-9) synthesized NaA type molecular sieves using alkali fused montmorillonite as raw material, and studied the composition of the clay/sodium carbonate mixture, as well as temperature and duration of alkali fusion. It was discovered that the target product of high purity could be attained with a relatively wide range of raw material proportion.

In the abovementioned references, calcination at high temperature or calcination by alkali fusion for mineral activation was employed in the preparation of zeolite 4A using kaolin or montmorillonite as raw material. The reason lies in that, in the above methods, the natural clay mineral raw materials in a crystalline state have a stable crystal structure where elemental silicon and aluminum are positioned within the mineral crystal lattice and may have reactivity sufficient for the molecular sieve synthesis only after being activated. However, current means of activation include primarily calcination at high temperature (about 800 to 1000° C.) or calcination by alkali fusion (about 600 to 800° C.), with high energy cost for the activation process and serious environmental pollution, not conforming to the trend of development in modern green chemical industry. Moreover, even though natural minerals may be activated by calcination at high temperature, the activation is ineffective, in particular, the Si—O bonds in the mineral can hardly be broken, which interferes with the utilization of silicon and aluminum species.

Recently, with the development in green chemistry, attention in research and development in novel chemical engineering processes has been drawn to usage of non-toxic and harmless raw materials, improvement of raw material utilization, lowering of energy cost during production as well as reduction in pollutant emission. Therefore, it is a huge challenge in molecular sieve synthesis using natural clay minerals activated in a low energy cost and high efficiency method.

### SUMMARY OF THE INVENTION

In order to solve the above problems, the present invention provides a method of synthesizing zeolite 4A, which method comprises:
providing the total silicon source and aluminum source required for zeolite 4A synthesis by using natural clay mineral, and activating the natural clay mineral followed by crystallization under hydrothermal conditions to synthesize zeolite 4A.

According to a particular embodiment of the present invention, in the synthesis method of zeolite 4A of the present invention, the natural clay mineral as mentioned refer to natural clay minerals having a silica-to-alumina ratio similar to that of zeolite 4A. Therefore, in the method according to the present invention, the natural clay mineral may be selected from natural minerals including montmorillonite, bentonite, attapulgite, and rectorite, in addition to kaolin. That is, the natural clay mineral used in the present invention may be selected from one or mixtures of more than one of natural kaolin, natural montmorillonite, natural bentonite, natural attapulgite, and natural rectorite.

According to a particular embodiment of the present invention, in the synthesis method of zeolite 4A of the present invention, the natural clay mineral as mentioned is activated by means of sub-molten salt activation.

Being an alkali/inorganic salt solution at high concentration, sub-molten salt is a class of untraditional media somehow between an aqueous solution and pure molten salt. To date, there is no research report on preparation of zeolite 4A using sub-molten salt-activated natural minerals as raw material. The present inventor has studied the characteristics of sub-molten salts which exhibit certain unique properties similar to those of molten salts. With excellent physical and chemical properties including low vapor pressure, good fluidity, high activity coefficient, and high reactivity, sub-molten salt media can provide highly chemically reactive and highly active negative oxygen ions, and acts well in dispersing and transferring of the reaction system, substantially increasing the reaction rate. It is discovered in the present application that sub-molten salt systems can effectively activate natural clay minerals for preparation of zeolite 4A under certain conditions, wherein the activation is carried out in a low energy-consuming way with little pollution.

According to a particular embodiment of the present invention, the sub-molten salt used in the present invention is a NaOH—H₂O sub-molten salt system. Specifically, the activation of the sub-molten salt in the present invention is carried out as follows: the natural clay mineral is evenly mixed with a NaOH solution in a mass ratio of 1:2 to 1:20, preferably in a mass ratio of 1:2 to 1:10, and then oven dried at 100° C. to 300° C. to give a product as activated clay mineral which can be used as raw material in zeolite 4A synthesis. More specifically, the NaOH solution is prepared by mixing solid NaOH with water in a mass ratio of 1:1 to 1:10.

According to a particular embodiment of the present invention, in the preparation of the zeolite 4A with activated clay mineral, activated natural mineral is used as the total silicon source and aluminum source, a synthesis system is adjusted to a molar ratio of 1 to 6 Na₂O:1.8 to 2.2 SiO₂:Al₂O₃:20 to 200 H₂O (i.e., activated natural clay needs to be mixed with deionized water according to this ratio to obtain the synthesis system, into which NaOH solution may be further added, if necessary, to adjust Na within the range of the above ratio), and the synthesis system is then subjected to crystallization to prepare zeolite 4A.

According to a particular embodiment of the present invention, with the synthesis method of zeolite 4A of the present invention, zeolite 4A as prepared has high whiteness and high calcium ion exchange capacity. The resultant zeolite 4A has whiteness of up to 90% or more and calcium exchange capacity of no less than 310 mg CaCO₃/g zeolite.

In particular, the synthesis method of zeolite 4A provided in the present invention comprises the following steps:
(1) activation of natural clay mineral: the natural clay mineral is evenly mixed with a NaOH solution in a mass ratio of 1:2 to 1:20, and then oven dried at 100° C. to 300° C. to give the raw material for zeolite 4A synthesis, wherein the NaOH solution is prepared by mixing solid NaOH with water in a mass ratio of 1:1 to 1:10;
(2) deionized water and NaOH are added into the synthesis raw material obtained in step (1), and the molar ratio of the material is adjusted to 1 to 6 Na₂O:1.8 to 2.2 SiO₂:Al₂O₃:20 to 200 H₂O, followed by aging under stirring and crystallization to obtain a crystallized product; and
(3) the crystallized product obtained in step (2) is cooled and filtered to remove the mother liquid, and the filter cake is washed with deionized water to have a neutral pH and then dried to obtain zeolite 4A.

According to a particular embodiment of the present invention, in step (2), the aging is performed at a temperature of 20° C. to 70° C. with a duration of 0 h to 24 h. For example, the synthesis system is aged under stirring at 20° C. to 70° C. for 0 h to 24 h, e.g., 0, 4, 6, 8, or 12 h. The crystallization procedure under hydrothermal conditions is generally carried out in a crystallization reaction vessel, where the crystallization is preferably performed at a temperature of 80° C. to 120° C. with a duration of 1 h to 12 h to afford the crystallized product.

The above crystallized product is further cooled down (may be cooled naturally) and filtered to remove the mother liquid, and the filter cake is washed with deionized water to have a neutral pH and then dried (may be naturally dried, or dried at 60 to 130° C.) to obtain zeolite 4A.

In the synthesis method of zeolite 4A of the present invention, any operation steps that are not detailed, for example, aging with stirring, filtering and washing of the crystallized product, etc., may be carried out with conventional means in the related field.

In the synthesis method of zeolite 4A of the present invention, the total silicon source and aluminum source required for molecular sieve synthesis are provided by the natural clay mineral as raw material, without adding chemical silicon source and aluminum source in any other forms, thereby broadening the application field of natural clay minerals and sources of raw materials for molecular sieve synthesis.

The synthesis method according to the present invention is advantageous in its simple procedure, readily available raw materials, low energy consumption with natural minerals, and little pollution. The molecular sieves synthesized in the present invention have characteristic XRD peaks of zeolite 4A. The resultant zeolite 4A exhibits superior properties, with whiteness of up to 90% or more and calcium ion exchange capacity of no less than 310 mg CaCO₃/g zeolite.

With the synthesis route provided in the present invention, not only the manufacturing cost for zeolite 4A synthesis is greatly reduced, but also the greenness in the synthesis process is significantly improved, resulting in molecular sieves having superior physical and chemical properties. Zeolite 4A is the most widely used molecular sieve material in applications in the detergent field and field of absorptive separation, and therefore the technique of synthesizing zeolite 4A using natural clay minerals with low energy consumption and little pollution as raw material in the present invention shows great prospect of application.

### BRIEF DESCRIPTION OF THE DRAWINGS

FIG. 1 is an XRD spectrum of zeolite 4A obtained in Example 1 of the present invention;

FIG. 2 is a SEM image of zeolite 4A obtained in Example 1 of the present invention with a magnification of 10,000×; and

FIGS. 3 to 8 are XRD spectra of zeolite 4A obtained in Examples 2 to 7 of the present invention, respectively.

### DETAILED DESCRIPTION OF THE INVENTION

Next, the present invention is further explained in combination with particular Examples, which is intended to describe in details the embodiments and features of the present invention, but not to be construed as limitation to the present application in any way. In the Examples:

Crystal phases of the products were measured by using a Shimadzu Lab XRD-600 X-ray diffractometer; crystal morphology of the products were observed under a Quanta 200F field emission scanning electronic microscope; and whiteness of the products were determined with a WSB-2 digital whiteness meter.

Determination of calcium ion exchange capacity were carried out following National Light Industry Standard QB 1768-93, specifically in the steps as below: 50 mL of a 0.05 mol/L calcium chloride solution was pipetted into a 500 mL volumetric flask, diluted with water to the scale mark, into which 3 drops (about 0.15 mL) of a 0.5 mol/L NaOH solution were added to adjust the pH of the solution to 10; then, the solution was transferred into a 1000 mL 3-neck flask equipped with a stirrer and a thermometer, with the other opening plugged, placed in a thermostatic water bath at 35° C., and stirred at a speed of more than 700 r/min without any spilling of the solution; when the solution reached the control temperature, a test portion wrapped in filter paper was dropped through plugged opening of the 3-neck flask, reacted for 20 min, and filtered by using chromatographic quantitative filter paper (a second filtration were to be conducted if the filtrate was not clear); the initial part of the filtrate was discarded, and 50 mL filtrate was drawn into a 250 mL Erlenmeyer flask, into which 2 mL of a 2.5 mol/L NaOH solution and a small amount (about 60 to 70 mg) of a calcium indicator were added, and the solution was titrated with an ethylene diamine tetraacetic acid (EDTA) solution; the endpoint was determined with a change of color from burgundy to blue, and the volume of the EDTA solution used was recorded. Calcium exchange capacity (E) of a molecular sieve was represented by micrograms of calcium carbonate per gram of anhydrate molecular sieve, and calculated according to the equation as follows: E=100.08×(50c₀−10c₁ V_{E})/[m×(1−X)]. In this equation, 100.08 was the molar mass of calcium carbonate, g/mol; c₀ was the concentration of the standard calcium chloride solution, mol/L; c₁ was the concentration of the EDTA standard solution, mol/L; V_{E} was the volume of the EDTA standard solution used during titration, mL; m was the mass of the test sample, g; X was the moisture absorption of the molecular sieve, %. The average of two measurements was taken as the measurement result.

Kaolin, rectorite, and montmorillonite as used were all commercially available products, wherein the principle components of the kaolin were: SiO₂ with a content of 50.5 wt. %, and Al₂O₃ with a content of 44.6 wt. %; the principle components of the rectorite were: SiO₂ with a content of 41.3 wt. %, and Al₂O₃ with a content of 38.2 wt. %; and the principle components of the montmorillonite were: SiO₂ with a content of 61.5 wt. %, and Al₂O₃ with a content of 18.2 wt. %.

### EXAMPLE 1

Commercial kaolin was oven dried, and pulverized into powder (the degree of pulverization was not specifically demanded in the present application, generally as long as the powder could get through a 20 mesh sieve upon pulverization). 10.00 g kaolin powder was weighed and evenly mixed with 84.00 g of a NaOH solution, and then oven dried at 200° C. before it was ready to use. Here, the NaOH solution was prepared by dissolving 14.00 g NaOH solid in 70.00 g deionized water.

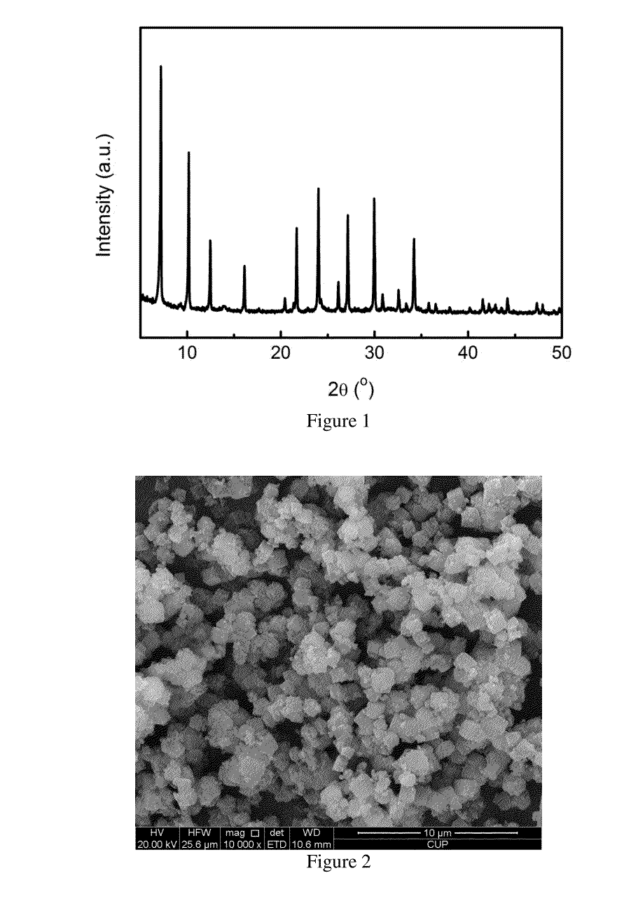

10.44 g of the above oven-dried kaolin powder was weighed, and mixed with 54.91 g deionized water added thereinto under stirring at 40° C. for 12 h. The mixture was poured into a Teflon-lined stainless steel autoclave, heated to 90° C. and allowed to crystallize at rest for 2 h. After the crystallization was completed, the mixture was cooled, filtered to remove the mother liquid, washed to have a neutral pH, and then dried at 120° C. to give a crystallized product. The phase thereof pertained to zeolite 4A as measured by XRD, the whiteness of zeolite 4A in the product was 93, with a calcium exchange capacity of 330 mg CaCO₃/g zeolite. The XRD spectrum was shown in FIG. 1, and the SEM image was shown in FIG. 2.

### EXAMPLE 2

Kaolin was pre-treated in the same way as in Example 1.

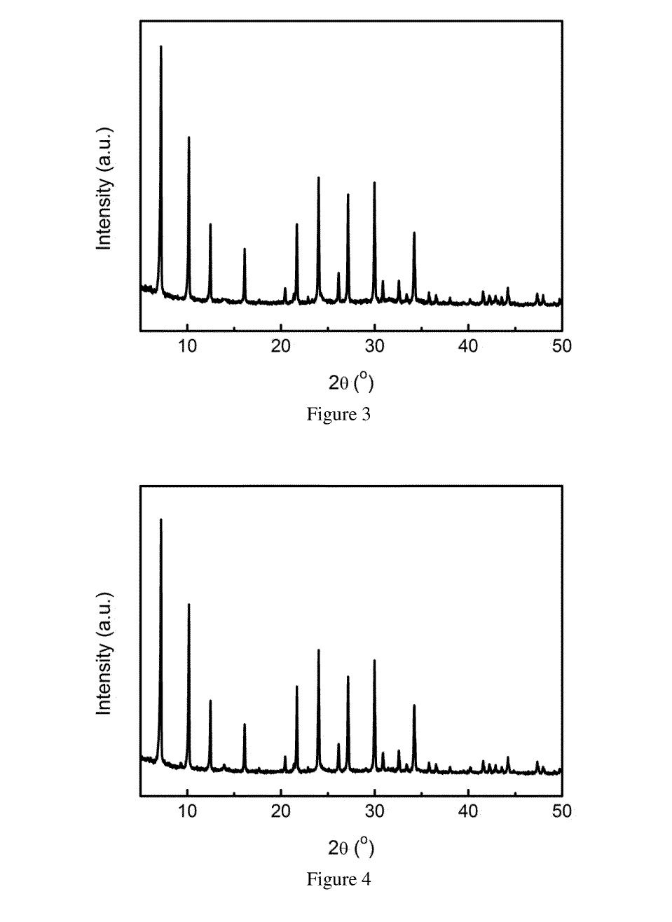

8.70 g of the oven-dried kaolin powder was weighed, and mixed with 51.48 g deionized water added thereinto under stirring at 20° C. for 4 h. The mixture was poured into a Teflon-lined stainless steel autoclave, heated to 100° C. and allowed to crystallize at rest for 6 h. After the crystallization was completed, the mixture was cooled, filtered to remove the mother liquid, washed to have a neutral pH, and then dried at 120° C. to give a crystallized product. The phase thereof pertained to zeolite 4A as measured by XRD, the whiteness of zeolite 4A in the product was 92, with a calcium exchange capacity of 312 mg CaCO₃/g zeolite. The XRD spectrum was shown in FIG. 3.

### EXAMPLE 3

Kaolin was pre-treated in the same way as in Example 1.

16.73 g of the oven-dried kaolin powder was weighed, and mixed with 43.93 g deionized water added thereinto under stirring at 60° C. for 8 h. The mixture was poured into a Teflon-lined stainless steel autoclave, heated to 100° C. and allowed to crystallize at rest for 4 h. After the crystallization was completed, the mixture was cooled, filtered to remove the mother liquid, washed to have a neutral pH, and then dried at 120° C. to give a crystallized product. The phase thereof pertained to zeolite 4A as measured by XRD, the whiteness of zeolite 4A in the product was 94, with a calcium exchange capacity of 320 mg CaCO₃/g zeolite. The XRD spectrum was shown in FIG. 4.

### EXAMPLE 4

Commercial kaolin was oven dried and pulverized into powder. 10.00 g kaolin powder was weighed and evenly mixed with 60.00 g of a NaOH solution, and then oven dried at 250° C. before it was ready to use. Here, the NaOH solution was prepared by dissolving 10.00 g NaOH solid in 50.00 g deionized water.

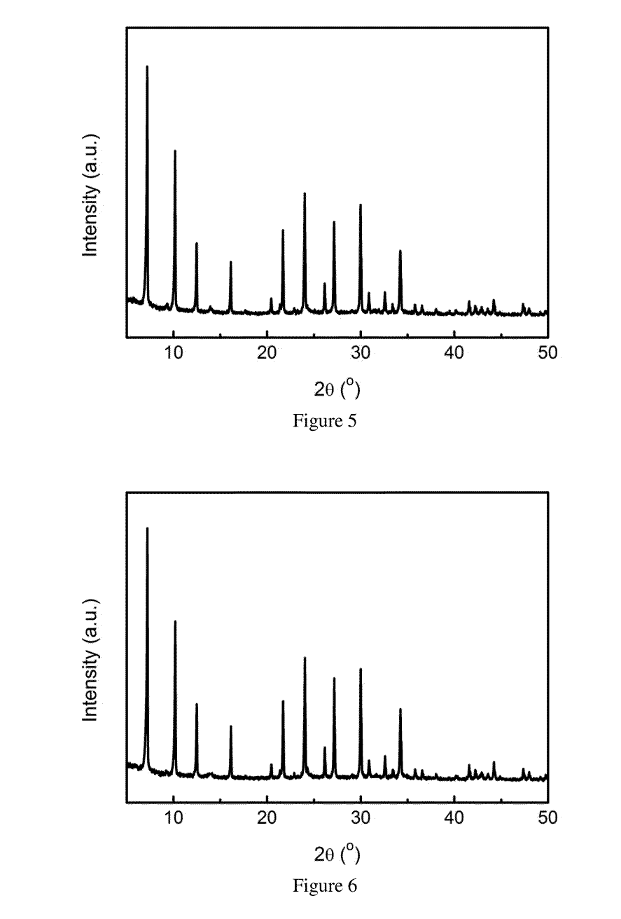

6.98 g of the above oven-dried kaolin powder was weighed, and mixed with 55.00 g deionized water added thereinto under stirring at 40° C. for 6 h. The mixture was poured into a Teflon-lined stainless steel autoclave, heated to 80° C. and allowed to crystallize at rest for 4 h. After the crystallization was completed, the mixture was cooled, filtered to remove the mother liquid, washed to have a neutral pH, and then dried at 120° C. to give a crystallized product. The phase thereof pertained to zeolite 4A as measured by XRD, the whiteness of zeolite 4A in the product was 91, with a calcium exchange capacity of 310 mg CaCO₃/g zeolite. The XRD spectrum was shown in FIG. 5.

### EXAMPLE 5

Commercial kaolin was oven dried and pulverized into powder. 10.00 g kaolin powder was weighed and evenly mixed with 96.00 g of a NaOH solution, and then oven dried at 150° C. before it was ready to use. Here, the NaOH solution was prepared by dissolving 16.00 g NaOH solid in 150.00 g deionized water.

12.09 g of the above oven-dried kaolin powder was weighed, and mixed with 55.00 g deionized water added thereinto under stirring at 40° C. for 6 h. The mixture was poured into a Teflon-lined stainless steel autoclave, heated to 80° C. and allowed to crystallize at rest for 10 h. After the crystallization was completed, the mixture was cooled, filtered to remove the mother liquid, washed to have a neutral pH, and then dried at 120° C. to give a crystallized product. The phase thereof pertained to zeolite 4A as measured by XRD, the whiteness of zeolite 4A in the product was 92, with a calcium exchange capacity of 315 mg CaCO₃/g zeolite. The XRD spectrum was shown in FIG. 6.

### EXAMPLE 6

Commercial rectorite was oven dried and pulverized into powder. 10.00 g rectorite powder was weighed and evenly mixed with 90.00 g of a NaOH solution, and then oven dried at 280° C. before it was ready to use. Here, the NaOH solution was prepared by dissolving 15.00 g NaOH solid in 15.00 g deionized water.

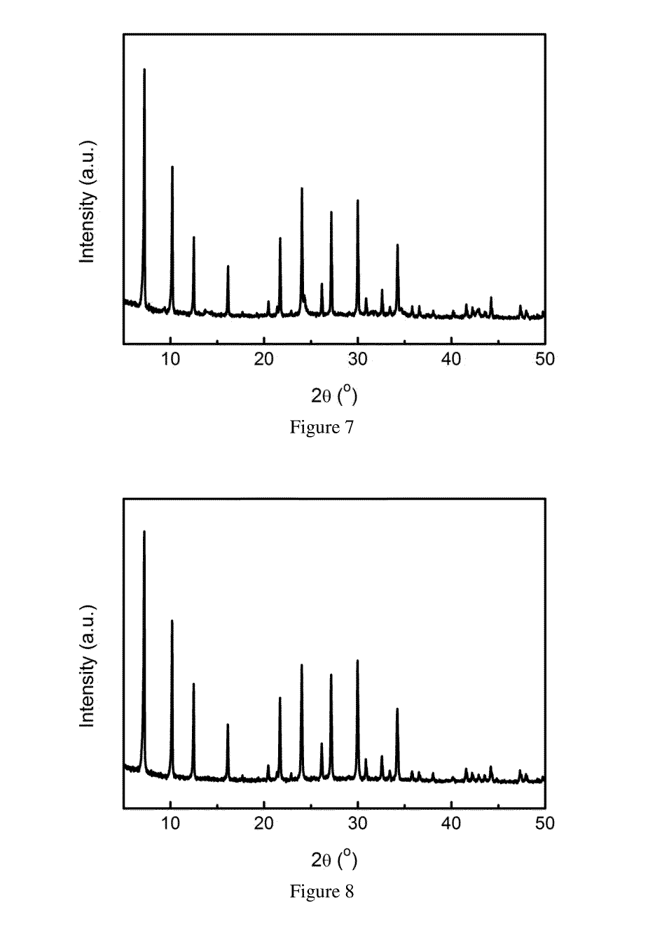

16.25 g of the above oven-dried rectorite powder was weighed, and mixed with 0.8 g NaOH solid and 55.00 g deionized water added thereinto under stirring at 40° C. for 20 h. The mixture was poured into a Teflon-lined stainless steel autoclave, heated to 90° C. and allowed to crystallize at rest for 2 h. After the crystallization was completed, the mixture was cooled, filtered to remove the mother liquid, washed to have a neutral pH, and then dried at 120° C. to give a crystallized product. The phase thereof pertained to zeolite 4A as measured by XRD, the whiteness of zeolite 4A in the product was 90, with a calcium exchange capacity of 323 mg CaCO₃/g zeolite. The XRD spectrum was shown in FIG. 7.

### EXAMPLE 7

Commercial kaolin, rectorite, and montmorillonite were oven dried and pulverized into powders. 10.00 g of a mixture of the three in a mass ratio of 1:1:0.2 was weighed and evenly mixed with 90.00 g of a NaOH solution, and then oven dried at 250° C. before it was ready to use. Here, the NaOH solution was prepared by dissolving 15.00 g NaOH solid in 75.00 g deionized water.

16.25 g of the above oven-dried mixture powder was weighed, and mixed with 0.8 g NaOH solid and 55.00 g deionized water added thereinto under stirring at 40° C. for 20 h. The mixture was poured into a Teflon-lined stainless steel autoclave, heated to 90° C. and allowed to crystallize at rest for 2 h. After the crystallization was completed, the mixture was cooled, filtered to remove the mother liquid, washed to have a neutral pH, and then dried at 120° C. to give a crystallized product. The phase thereof pertained to zeolite 4A as measured by XRD, the whiteness of zeolite 4A in the product was 92, with a calcium exchange capacity of 313 mg CaCO₃/g zeolite. The XRD spectrum was shown in FIG. 8.

### COMPARATIVE EXAMPLE 1

Commercial kaolin was oven dried and pulverized into powder. 10.00 g kaolin powder was weighed and evenly mixed with 48.00 g of a NaOH solution, and then oven dried at 250° C. before it was ready to use. Here, the NaOH solution was prepared by dissolving 8.00 g NaOH solid in 40.00 g deionized water.

9.00 g of the above oven-dried kaolin powder was weighed, and mixed with 54.00 g deionized water added thereinto under stirring at 40° C. for 12 h. The mixture was poured into a Teflon-lined stainless steel autoclave, heated to 90° C. and allowed to crystallize at rest for 4 h. After the crystallization was completed, the mixture was cooled, filtered to remove the mother liquid, washed to have a neutral pH, and then dried at 120° C., resulting in no zeolite 4A.

### COMPARATIVE EXAMPLE 2

Commercial kaolin was oven dried and pulverized into powder. 10.00 g kaolin powder was weighed and evenly mixed with 25.20 g of a NaOH solution, and then oven dried at 250° C. before it was ready to use. Here, the NaOH solution was prepared by dissolving 14.00 g NaOH solid in 11.20 g deionized water.

10.44 g of the above oven-dried kaolin powder was weighed, and mixed with 54.91 g deionized water added thereinto under stirring at 40° C. for 12 h. The mixture was poured into a Teflon-lined stainless steel autoclave, heated to 90° C. and allowed to crystallize at rest for 4 h. After the crystallization was completed, the mixture was cooled, filtered to remove the mother liquid, washed to have a neutral pH, and then dried at 120° C., resulting in no zeolite 4A.

As demonstrated by the above Examples and Comparative Examples, the total silicon source or aluminum source required for synthesis was provided by natural kaolin mineral activated with sub-molten salt, and zeolite 4A prepared through hydrothermal crystallization under suitable conditions showed excellent physical and chemical properties, with a lower cost for the synthesis thereof.

1. A synthesis method of zeolite 4A, comprising:
providing the total silicon source and aluminum source required for molecular sieve synthesis by using natural clay mineral, and
activating the natural clay mineral followed by crystallization under hydrothermal conditions to synthesize zeolite 4A.

2. The synthesis method of zeolite 4A according to claim 1, wherein the natural clay mineral is selected from the group consisting of natural kaolin, natural montmorillonite, natural attapulgite, natural rectorite and mixtures of one or more of the foregoing minerals.

3. The synthesis method of zeolite 4A according to claim 1, wherein the natural clay mineral is activated by means of sub-molten salt activation.

4. The synthesis method of zeolite 4A according to claim 3, wherein the sub-molten salt is a NaOH-H2O sub-molten salt system.

5. The synthesis method of zeolite 4A according to claim 1, wherein the zeolite 4A has high whiteness and high calcium ion exchange capacity.

6. The synthesis method of zeolite 4A according to claim 1, wherein the activation is carried out as follows:
the natural clay mineral is evenly mixed with a NaOH solution in a mass ratio of 1:2 to 1:20, and then oven dried at 100° C. to 300° C. to give a product as activated clay mineral;
wherein, the NaOH solution is prepared by mixing solid NaOH with water in a mass ratio of 1:1 to 1:10.

7. The synthesis method of zeolite 4A according to claim 3, wherein the activation is carried out as follows:
the natural clay mineral is evenly mixed with a NaOH solution in a mass ratio of 1:2 to 1:20, and then oven dried at 100° C. to 300° C. to give a product as activated clay mineral;
wherein, the NaOH solution is prepared by mixing solid NaOH with water in a mass ratio of 1:1 to 1:10.

8. The synthesis method of zeolite 4A according to claim 1, wherein, in the preparation of zeolite 4A with activated clay mineral, the activated natural clay is used as the total silicon source and aluminum source, a synthesis system is adjusted into a molar ratio of 1 to 6 Na2O:1.8 to 2.2 SiO2:Al2O3:20 to 200 H2O, and then subjected to crystallization under hydrothermal conditions to synthesize zeolite 4A.

9. The synthesis method of zeolite 4A according to claim 3, wherein, in the preparation of zeolite 4A with activated clay mineral, the activated natural clay is used as the total silicon source and aluminum source, a synthesis system is adjusted into a molar ratio of 1 to 6 Na2O:1.8 to 2.2 SiO2:Al2O3:20 to 200 H2O, and then subjected to crystallization under hydrothermal conditions to synthesize zeolite 4A.

10. The synthesis method of zeolite 4A according to claim 1, comprising the following steps:
(1) activating the natural clay mineral, wherein the natural clay mineral is evenly mixed with a NaOH solution in a mass ratio of 1:2 to 1:20, and then oven dried at 100° C. to 300° C. to give the raw material for zeolite 4A synthesis, wherein the NaOH solution is prepared by mixing solid NaOH with water in a mass ratio of 1:1 to 1:10;
(2) adding deionized water and NaOH into the synthesis raw material obtained in step (1), and adjusting the molar ratio of the material is to 1 to 6 Na2O:1.8 to 2.2 SiO2:Al2O3:20 to 200 H2O, followed by aging under stifling and crystallization to obtain a crystallized product; and
(3) cooling and filtering the crystallized product obtained in step (2) to remove the mother liquid, wherein the filter cake is washed with deionized water to have a neutral pH and then dried to obtain zeolite 4A.

11. The synthesis method of zeolite 4A according to claim 3, comprising the following steps:
(1) activating the natural clay mineral, wherein the natural clay mineral is evenly mixed with a NaOH solution in a mass ratio of 1:2 to 1:20, and then oven dried at 100° C. to 300° C. to give the raw material for zeolite 4A synthesis, wherein the NaOH solution is prepared by mixing solid NaOH with water in a mass ratio of 1:1 to 1:10;
(2) adding deionized water and NaOH into the synthesis raw material obtained in step (1), and adjusting the molar ratio of the material is to 1 to 6 Na2O:1.8 to 2.2 SiO2:Al2O3:20 to 200 H2O, followed by aging under stirring and crystallization to obtain a crystallized product; and
(3) cooling and filtering the crystallized product obtained in step (2) to remove the mother liquid, wherein the filter cake is washed with deionized water to have a neutral pH and then dried to obtain zeolite 4A.

12. The method according to claim 10, wherein, in step (2), the aging is performed at a temperature of 20° C. to 70° C. with a duration of 0 h to 24 h.

13. The method according to claim 11, wherein, in step (2), the aging is performed at a temperature of 20° C. to 70° C. with a duration of 0 h to 24 h.

14. The method according to claim 10, wherein, in step (2), the crystallization is performed at a temperature of 80° C. to 120° C. with a duration of 1 h to 12 h.

15. The method according to claim 11, wherein, in step (2), the crystallization is performed at a temperature of 80° C. to 120° C. with a duration of 1 h to 12 h.
